(19) United States
(12) Patent Application Publication
(10) Pub. No.: US 2005/0066033 A1
(43) Pub. Date: Mar. 24, 2005

(54) Apparatus, system, and method for dynamic selection of best network service

(76) Inventors: Richard W. Cheston, Morrisville, NC (US); Daryl Carvis Cromer, Apex, NC (US); Howard Jeffrey Locker, Cary, NC (US)

Correspondence Address: KUNZLER & ASSOCIATES, 8 EAST BROADWAY, SUITE 600, SALT LAKE CITY, UT, 84111, US

(21) Appl. No.: 10/669,750

(22) Filed: Sep. 24, 2003

(51) Int. Cl. G06F 15/173

(52) U.S. Cl. 709/225

(57) ABSTRACT

An apparatus, system, and process are disclosed for dynamically determining a best network service for an electronic computing device. A network query module queries two or more active networks to determine the network characteristics, such as bandwidth, security level, and cost, of each network. A service level module determines a service level associated with each active network. The service level is determined based on an algorithm using the network characteristics of each network. A best network module determines the best network from the active networks based on the service levels of each network, and a network connection module dynamically connects the electronic computing device to the best network. The network selection apparatus may also maintain and use a profile module to store default, user-defined, application, and network profiles. A dynamic switching module may dynamically switch between active networks as the service levels of individual networks are re-evaluated and the network characteristics of each network change.

### BACKGROUND OF THE INVENTION

1. Field of the Invention

This invention relates to an electronic computing device connecting to a network and more particularly relates to determining a best network service for an electronic computing device when multiple networks are available and dynamically switching among multiple networks according the best available network service.

2. Description of the Related Art

Internet service providers are creating networking “hot spots” in all sorts of public and private locations, including hotels, motels, airports, bookstores, coffee shops, and so forth. For example, many airports allow service providers to make hardwire and wireless network connections available to fee-paying subscribers. In fact, in many areas, a single user may potentially have access to multiple networks at any one time.

For example, a person using a laptop computer may have hardwire access to a first LAN network, wireless Wi-Fi access to a second network and a third network, wireless Bluetooth access to a fourth network, and hardwire access to a fifth WAN network. In this scenario, each of the five networks may be a separate network having distinct network characteristics, such as cost, security, bandwidth, and other network characteristics. It is also possible for a single computer to have multiple service providers operating on the same network protocol. As an example, a user may have two or more Wi-Fi or WAN accounts from different service providers, each having different network characteristics.

Currently, the manner in which an electronic computing device switches between networks is simplistic and does not take into account any specified needs of the user. For example, one manner in which an electronic computing device may switch between available networks is through bandwidth selection that connects the electronic computing device to the network having the most bandwidth. For example, if a laptop computer is currently connected to a wireless Wi-Fi network, such as an IEEE 802.11b network with a maximum bandwidth of 11 Mbs, the laptop will switch to a wired LAN connection, such as a 100Base-T or a gigabit Ethernet having a higher bandwidth of 100 Mbs or 1,000 Mbs. However, there is no consideration for the cost or level of security of either network or any other network characteristic other than bandwidth.

Another manner in which electronic computing devices select networks, in the case of multiple available wireless networks, is through a first-active approach. For example, a laptop computer capable of wireless Wi-Fi networking may be within range of a plurality of active Wi-Fi networks. The conventional manner of selecting one of the many Wi-Fi networks is simply to connect to the first available network. If the laptop computer recognizes other networks after connecting to the first active network, a user would have to manually switch to the subsequent network. In a related manner, a user may conventionally specify an order in which the laptop computer should attempt to connect to each of the networks if multiple networks are simultaneously available. Neither of these connection schemes, however, takes into account the actual performance of the wireless Wi-Fi network or the performance requirements of the user or application software.

A third manner in which an electronic computing device select networks is to indicate a preference for “indoor” networks over “outdoor” networks. This may be related to the manner referenced above in that a user may simply specify a preference for a network that is known to be available inside a building over a network that is generally available outside.

For example, a personal digital assistant (PDA) may be configured to connect to any available network and, in one scenario, connects to a metropolitan area network (MAN) available outside in a downtown area. The PDA may be programmed to prefer a wireless Bluetooth network available indoors in a business office and to automatically switch to the indoor Bluetooth network instead of the outdoor MAN network. But, once again, no consideration is given to the specific network performance needs of a user or application. The switch is simply from an outdoor network to an indoor network.

Consequently, a need exists for a process, apparatus, and system for determining a best network service for an electronic computing device from among a plurality of different network types and services. Beneficially, such a process, apparatus, and system would take into account the network performance requirements of a particular user or of a specific application program. Likewise, such a process, apparatus, and system would beneficially be resident within the electronic computing device and operate independently from and transparently with the plurality of active networks available to the electronic computing device.

### BRIEF SUMMARY OF THE INVENTION

The present invention has been developed in response to the present state of the art, and in particular, in response to the problems and needs in the art that have not yet been fully solved by currently available network selection means and methods. Accordingly, the present invention has been developed to provide a process, apparatus, and system for determining a best network service for an electronic computing device that overcome many or all of the above-discussed shortcomings in the art.

The apparatus for determining a best network service for an electronic computing device is provided with a logic unit containing a plurality of modules configured to functionally execute the necessary steps of determining a best network service for an electronic computing device. These modules in the described embodiments include network query module, a determination module, a network connection module, a profile module, a type module, a cost module, a security module, a bandwidth module, a signal module, a time module, a mobility module, a service level module, a best network module, an evaluation module, an a dynamic switching module.

The apparatus, in one embodiment, includes the network query module, the service level module, the best network module, and the network connection module. In this embodiment, the apparatus is broadly configured to query a plurality of networks for corresponding network characteristics, determine a service level associated with each network, determine a best network from the plurality of networks based on the service level of each network, and dynamically connect the electronic computing device to the best network.

In a further embodiment, the service level module may be configured to determine the service level of a given network by implementing an algorithm that weighs each of the network characteristics for a specific network. The algorithm may weigh each network characteristic equally, in one embodiment, or may weigh each network characteristic according to a ranking, a user-defined weighting, an application-specific weighting, or another form of weighting selected or determined by the user or apparatus.

One embodiment of the apparatus further includes the evaluation module configured to evaluate the actual network characteristics of a connected network, as opposed to the network characteristics of an available, but not connected, network. For example, a wired 100Base-T LAN network that generally has a bandwidth of 100 Mbs may have an actual bandwidth of only 10 Mbs due to high traffic, a poor connection, or one of a number of other reasons. The evaluation module may be configured to recognize this decrease in performance and allow the network selection apparatus to determine a new service level for the connected network. The new service level may be lower than the previously determined service level.

A further embodiment of the apparatus includes the dynamic switching module to dynamically disconnect the electronic computing device from a previously best network before dynamically connecting the electronic computing device to a new best network. For example, a PDA may be connected to a first of two available wireless Bluetooth networks. If the service level, based on the network characteristics, of the first network decreases, the dynamic switching module within the network selection apparatus resident on the PDA may dynamically switch from the first network to the second network if the second network offers a higher service level than the first network.

Another embodiment of the apparatus includes the profile module to maintain one or more profiles. In one embodiment, the profile module may include network profiles descriptive of the active networks available to the electronic computing device. A network profile may describe the type of network, as well as other network characteristics including bandwidth, security level, cost, and so forth.

The profile module also may include user profiles in the form of default, user-defined, and application-specific profiles. The network selection apparatus may be configured to select a best network based on the similarities between a specific user profile and the determined network profile of each active network. A default profile may be defined to prefer a certain type of network or a certain network characteristic, such as bandwidth, security, or cost. Likewise, a user-defined profile may be defined by a user according to the network performance needs or wants of the user.

Similarly, an application profile may be defined be a user, an application program, or by another entity to optimize network selection based on the performance requirements of a specific application, such as banking, internet browsing, audiovisual processing, or another application. In one embodiment, the profile module may include a minimum service level, such as a minimum security level of the network, that ensures that the electronic computing device will only connect to a network meeting at least the minimum specified requirements.

A system of the present invention is also presented for determining a best network service for an electronic computing device. The system may be embodied in an application on a laptop computer, a workstation, a personal digital assistant, or any other electronic computing device. In particular, the system, in one embodiment, includes an electronic computing device capable of detecting active networks and connecting to one or more of the active networks. The system also includes a network selection apparatus as describe above, specifically configured to use a weighted algorithm to determine a best network based on the network characteristics of the active networks.

The system, in a further embodiment, may include a first network having a plurality of first network characteristics, a second network having a plurality of second network characteristics, and the electronic computing device. The electronic computing device may include a resident network selection apparatus, including the network query module, the service level module, the best network module, and the network connection module as described above.

A process of the present invention is also presented for determining a best network service for an electronic computing device. The process in the disclosed embodiments substantially includes the steps necessary to carry out the functions presented above with respect to the operation of the described apparatus and system. In one embodiment, the process includes querying a first network for a plurality of first network characteristics and querying a second network for a plurality of second network characteristics, determining a first network service level based on an influenced algorithm using the plurality of first network characteristics and determining a second network service level based on the influenced algorithm using the plurality of second network characteristics, determining a best network from the first and second networks based on the first and second service levels, and dynamically connecting the electronic computing device to the best network.

The process also may include determining the first network service level based on the influenced algorithm by allowing one of the plurality of first network characteristics to influence the determination of the first service level a first amount and allowing another of the plurality of first network characteristics to influence the determination of the first service level a second amount. The network characteristics may be weighed equally, in one embodiment, or may be weighed independently, in another embodiment.

In a further embodiment, the process includes determining an actual best network service level based on the influenced algorithm using the plurality of actual best network characteristics. The process also may include dynamically disconnecting the electronic computing device from a previous best network and dynamically connecting the electronic computing device to a new best network. A further embodiment of the process includes maintaining the network, default, user-defined, and application profiles as described above.

One of the features of one embodiment of the present invention is the implementation of a client-side application that may be resident on a client device, such as a workstation, laptop, or PDA, and operate independently of any active networks. Another advantage of one embodiment of the present invention over conventional technology is the capability to consider multiple network characteristics in determining a network service level or a best network. A further feature of one embodiment of the present invention is the “self-learning” capability of the network selection apparatus to re-evaluate the network characteristics of a connected network and determine if the service level of the connected network has changed.

Another advantage of one embodiment of the network selection apparatus described herein is that the network selection apparatus may use one or more profiles that may define the network requirements of a particular user or specific application. The profiles, including a plurality of network characteristic preferences, may be the basis for determining a network service level and, in turn, be used to determine the best network.

Reference throughout this specification to features, advantages, or similar language does not infer that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These and many other features and advantages of the present invention will more fully become apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a multiple network system in accordance with the present invention;

FIG. 2 is a schematic block diagram illustrating one embodiment of an electronic computing device in accordance with the present invention;

FIG. 3 is a schematic block diagram illustrating one embodiment of a communications adapter in accordance with the present invention;

FIG. 4 is a schematic block diagram illustrating one embodiment of a network selection apparatus in accordance with the present invention;

FIG. 5 is a schematic flow chart diagram illustrating one embodiment of a dynamic network selection process in accordance with the present invention;

FIG. 6 is a schematic flow chart diagram illustrating another embodiment of a dynamic network selection process in accordance with the present invention;

FIG. 7 is a schematic flow chart diagram illustrating one embodiment of a network query process in accordance with the present invention;

FIG. 8 is a schematic flow chart diagram illustrating one embodiment of a determination process in accordance with the present invention; and

FIG. 9 is a schematic flow chart diagram illustrating one embodiment of a network connection in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

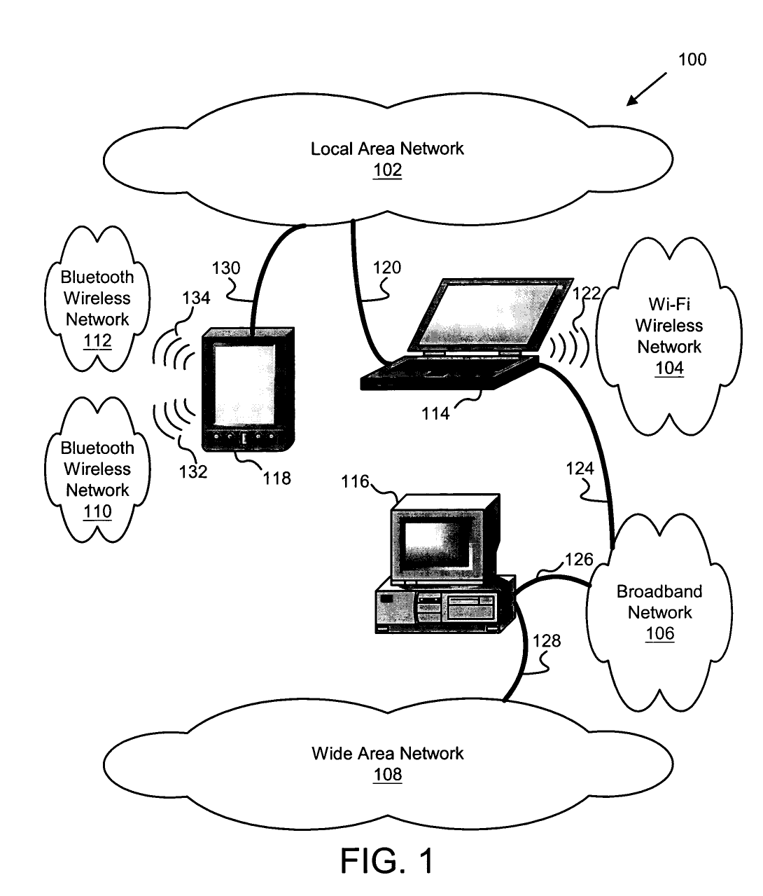

FIG. 1 depicts one embodiment of a multiple network system 100 that includes a local area network (LAN) 102, a wireless fidelity (Wi-Fi) wireless network 104, a broadband network 106, a wide area network (WAN) 108, a first Bluetooth wireless network 110, and a second Bluetooth wireless network 112. The illustrated multiple network system 100 also includes a plurality of electronic computing devices, such as a laptop computer 114, a personal computer (PC) 116, and a personal digital assistant (PDA) 118.

In one embodiment, the Wi-Fi wireless network 104 may be an IEEE 802.11a, IEEE 802.11b, or IEEE 802.11 g wireless network. The Wi-Fi wireless network 104 also may be another wireless network using an acceptable Wi-Fi standard. Likewise, the broadband network 106 may be a digital subscriber line (xDSL) network or a coaxial cable network. The xDSL network may be an asymmetric DSL (ADSL) network, a symmetric DSL (SDSL) network, a high data rate DSL (HDSL) network, or a very high data rate DSL (VDSL) network. Additionally, the local area network (LAN) 102 and wide area network (WAN) 108 may be an Ethernet network, such as a 10Base-T, 100Base-T, or gigabit Ethernet.

In another embodiment, the multiple network system 100 may also include an integrated services digital network (ISDN), an alternative wireless LAN such as a HomeRF network or a HiperLAN network, a wireless WAN, a campus area network (CAN), a metropolitan area network (MAN), a home area network (HAN), or any other network that is configured to allow a user to connect and transfer electronic data. A wireless WAN or other similar network may be a code division multiple access (CDMA) network, a general packet radio service (GPRS) network, or another type of acceptable wireless WAN network. Furthermore, each of the depicted or described networks may employ similar or dissimilar network topologies, transmission protocols, or architectures. Although may types of networks are described within this description of the invention, it will be understood that the present invention is not limited to a particular type or types of networks, but is intended to communicate using a variety of networks, topologies, protocols, and architectures, depending on the networking capabilities of a particular electronic computing device.

The term “connected,” as used throughout this description may refer to the mere presence of a communications channel, whether wireless or wired, between an electronic computing device and an active network or may refer to the established communications between an electronic computing device and an available network. In one embodiment, an electronic computing device may be connected to an active network, but not specifically communicating additional data to the network, except to acknowledge that the network is active and may be used for communications. In another embodiment, an electronic computing device may be connected to an available network and communicating information over the connected network.

Generally, an “active network” is a network, either wired or wireless, that is operational near an electronic computing device. An “available network” is generally an active network that is available for use by an electronic computing device. The data communicated between an electronic computing device and an active network to determine if the network is available may be referred to as “connection data.” The data communicated over a available network by an application, such as an internet browser, running on an electronic computing device may be referred to as “application data.”

In a certain embodiment, the laptop computer 114 is connected to the local area network (LAN) 102 via a LAN connection 120, to the 802.11 g wireless network 104 via a wireless connection 122, and to the broadband network 106 via a broadband connection 124. Similarly, the personal computer (PC) 116 is connected to the broadband network 106 via a broadband connection 126 and to the wide area network (WAN) 108 via a WAN connection 128. Likewise, the personal digital assistant (PDA) 118 is connected to the local area network 102 via a LAN connection 130, and to the first and second Bluetooth wireless networks 110, 112 via respective wireless connections 132, 134. In one embodiment, the LAN connections 120, 130, broadband connection 124, 126, and WAN connection 128 may comprise twisted pair, coaxial, or fiber optic cable. Generally, the wireless connections 122, 132, 134 are radio waves.

In another embodiment, one or all of the depicted electronic computing devices 114, 116, 118 may have multiple connections to a single network. For example, the laptop computer 114, may have multiple LAN connections 120 that comprise distinct subscriber accounts. The multiple LAN connections 120 physically may be independent of one another or may be a single physical cable. In fact, a single network connection may include multiple connection points, such as at the laptop computer, at a wall telephonejack, a a network server, at an internet service provider (ISP), and so forth. In one embodiment, several network connections may share at utilize a common portion of the physical cabling, such as from the electronic computing device to a demarcation point (the location at which a telephone line enters a building). In a further embodiment, the several network connections may include distinct physical cables depending on the ISP for each available subscriber account.

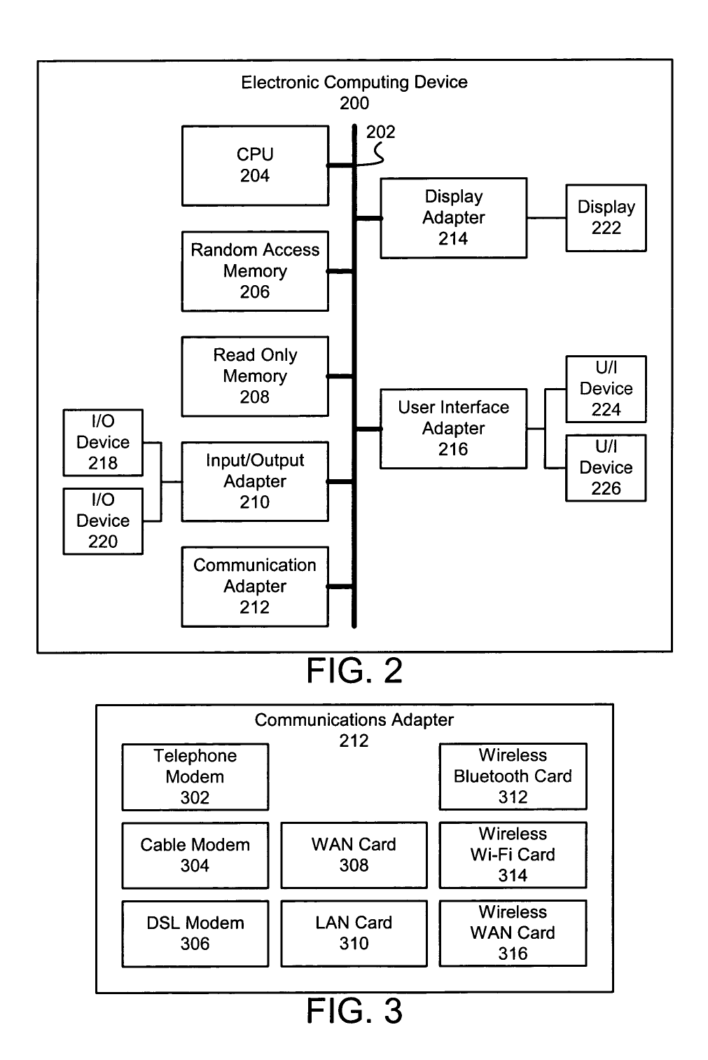

FIG. 2 depicts one embodiment of an electronic computing device 200 that may be embodied in the form of the laptop computer 114, the personal computer (PC) 116, the personal digital assistant (PDA) 118, or another electronic computing device capable of connecting to one or more networks. The depicted electronic computing device 200 includes a communications bus 202, a central processing unit (CPU) 204, a random access memory (RAM) 206, a read only memory (ROM) 208, an input/output (I/O) adapter 210, a communications adapter 212, a display adapter 214, and a user interface (U/I) Adapter 216.

The illustrated I/O adapter 210 is connected to multiple I/O devices 218, 220, such as a printer or an electronic storage device. The illustrated display adapter 214 is connected to a display 222, such as a CRT or LCD screen. The illustrated U/I adapter 216 is connected to multiple U/I devices 224, 226, such as a mouse, a touchpad, or a keyboard.

FIG. 3 depicts one embodiment of the communications adapter 212 from the electronic computing device 200 shown in FIG. 2. The depicted communications adapter 212 includes a telephone modem 302, a cable modem 304, a DSL modem 306, a WAN card 308, a LAN card 310, a wireless Bluetooth card 312, a wireless Wi-Fi card 314, and a wireless WAN card 316. The telephone modem 302 is configured to transfer and receive data over a telephone line. Likewise, the cable modem 304 is configured to transfer and receive data over a coaxial cable. Similarly, the DSL modem 306 is configured to transfer and receive data over a DSL cable, such as a telephone line or a category 5e (CAT5e) twisted pair.

The WAN card 308 and the LAN card 310 are each configured to transfer and receive data over the WAN network 108 and the LAN network 102, respectively, using an appropriate medium as described above with reference to FIG. 1. Also, the wireless Bluetooth, Wi-Fi, and WAN cards 312, 314, 316 are configured to transmit and receive data via respective wireless mediums and transmission protocols described above with reference to FIG. 1. In one embodiment, there may be multiple service providers through which any single card 308, 310, 312, 314, 316 may connect to a particular network. For example, a user may connect to the Wi-Fi wireless network 104 via the wireless Wi-Fi card 314 through a Sprint account, an AT&T account, a T-mobile account, a corporate account, a home account, or another Wi-Fi wireless account. In this way, a single user may connect to a particular network through one of a plurality of network connections and corresponding subscriber accounts.

Although the communications adapter 212 of FIG. 3 is shown having a plurality of specific network adapters, the communications adapter 212 of a given electronic computing device 200 may have more or less network adapters. Furthermore, the communications adapter 212 of a given electronic computing device 200 may have different types of network adapters instead of or in addition to the types of network adapters illustrated in FIG. 3, depending on the networking capabilities of the given electronic computing device 200.

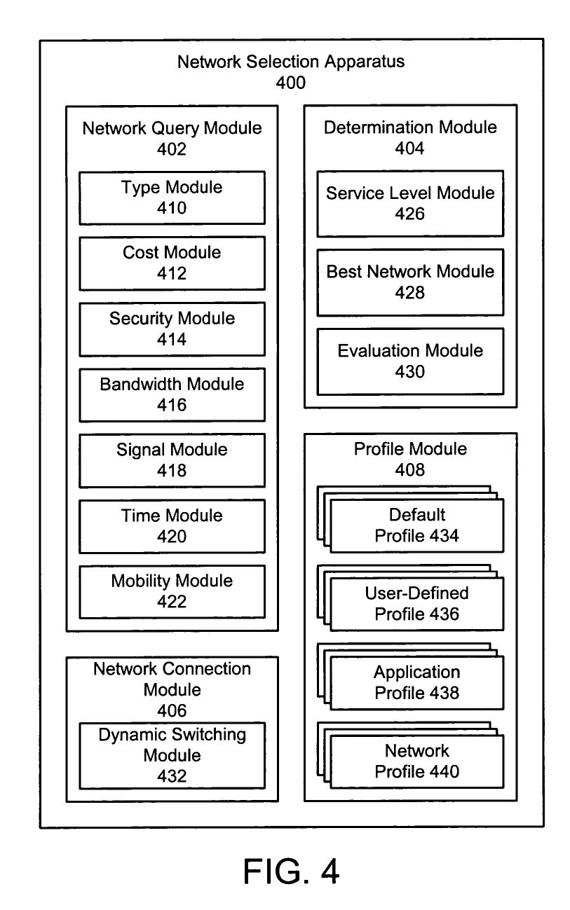

FIG. 4 depicts one embodiment of a network selection apparatus 400 that may be resident within and employed in conjunction with the electronic computing device 200 of FIG. 2. The depicted network selection apparatus 400 includes a network query module 402, a determination module 404, a network connection module 406, and a profile module 408. The network selection apparatus 400 is generally configured to determine a best network service from among multiple available network services. For example, referring to the laptop computer 114 of FIG. 1, a network selection apparatus 400 resident within the laptop computer 114 may recognize that three network connections, namely the local area network (LAN) 102, the Wi-Fi wireless network 104, and the broadband network 106, are active and available to the laptop computer 114. In this example, the network selection apparatus 400 may determine which of the available networks 102, 104, 106 offers the best network service to the laptop computer 114, possibly taking into account the user-defined needs, the application-specific needs, and the characteristics of each of the available networks 102, 104, 106.

The network query module 402, in one embodiment, is configured to query each of the networks available to a given electronic computing device 200 and determine certain characteristics of each network. In order to determine certain characteristics of each network, the depicted network query module 402 includes a type module 410, a cost module 412, a security module 414, a bandwidth module 416, a signal module 418, a time module 420, and a mobility module 422.

The type module 410 determines the type of network that is available, such as whether the network is a LAN, a wireless LAN, a WAN, or another type of network. The type module 410 may also determine more specifically the topology, transmission protocol, architecture, and so forth, to the extent it is known, that describes a particular available network.

The cost module 412 is configured, in one embodiment, to determine if a cost is assessed for using each of the networks available to an electronic computing device 200. For example, a dial-up ISDN network may have an associated cost that depends on the time that the electronic computing device is connected to the network. Similarly, a Wi-Fi network may charge a monthly subscription fee. However, in one embodiment, the electronic computing device 200 also may be connected to a MAN that does not charge a fee to the user.

The security module 414 is configured, in one embodiment, to determine the security level available using each of the networks available to an electronic computing device 200. Similarly, the bandwidth module 416 is configured, in one embodiment, to determine the bandwidth available to the electronic computing device 200 using each of the available networks. In a further embodiment, the bandwidth module 416 may be configured to determine an actual bandwidth, as opposed to an optimum bandwidth, that is available to the electronic computing device 200.

The signal module 418 is configured, in one embodiment, to determine the signal strength of an available wireless network, such as the Wi-Fi wireless network 104 or the Bluetooth wireless networks 110, 112 of FIG. 1. The time module 420 may be configured, in one embodiment, to determine the amount of time a given data transfer or application procedure will require using each of the available networks. In a further embodiment, the time module 420 may determine if any time limits, such as a 15 minute log-on period, are placed on any of the available networks. The mobility module 422 is configured, in one embodiment, to determine the mobility characteristics of each network. In some cases, the mobility characteristics may depend on the connection type, whether wired or wireless. In other circumstances, the mobility characteristics may depend in part on the coverage area, which may be related to the signal strength, of a wireless network.

By way of example, Table 1 shows a possible collection of network characteristics for four different networks that may be active and available to a single electronic computing device 200. The four networks are designated NET01, NET02, NET03, and NET04. For each of the four networks, a plurality of characteristics may be rated, in one embodiment, such as using a scale between 0 and 10, with 10 indicating a strong characteristic and 0 indicating a weak characteristic. In an alternative embodiment, the characteristics may be ranked according to strength or presence, or may be indicated in another suitable manner. In Table 1, each of a plurality of network characteristics is assigned a value of 0, 1, 5, or 10 depending on the availability and strength or quality of the characteristic.

For example, NET01 is a wireless Wi-Fi network that has a low cost, a high bandwidth, a high mobility, a medium-strength wireless signal, a medium-length connection time, and a relatively low security level. Characteristics of each of the other three networks are also described in Table 1. Other equivalent means of determining the characteristics of a specific network may be employed without significantly departing from the design and functionality of the present invention.

TABLE 1
Network Profile

| | NET01 | NET02 | NET03 | NET04 |
|---|---|---|---|---|
| Low_Cost | 10 | 10 | 1 | 5 |
| High_Security | 1 | 10 | 10 | 5 |
| High_Bandwidth | 10 | 1 | 10 | 1 |
| Strong_Signal_Strength | 5 | 10 | 10 | 5 |
| Long_Time_Remaining | 5 | 5 | 10 | 1 |
| Mobility | 10 | 1 | 1 | 10 |
| Type_Wired_ISDN | 0 | 10 | 0 | 0 |
| Type_Wired_Broadband | 0 | 0 | 10 | 0 |
| Type_Wired_WAN | 0 | 0 | 0 | 0 |
| Type Wired_LAN | 0 | 0 | 0 | 0 |
| Type_Wireless_WAN | 0 | 0 | 0 | 0 |
| Type_Wireless_Wi-Fi | 10 | 0 | 0 | 0 |
| Type_Wireless_BT | 0 | 0 | 0 | 10 |

The determination module 404 of the network selection apparatus 400, in one embodiment, is configured to determine how closely one or all of the available networks compares to a set of specified network characteristics. In the depicted embodiment, the determination module 404 includes a service level module 426, a best network module 428, and an evaluation module 430.

The service level module 426 may be configured, in one embodiment, to determine a service level that corresponds to each of the available networks. For example, the service level module 426 may determine a service level for each of the three networks 120, 122, 124 that are available to the laptop computer 114. The service level for each available network may be determined by the service level module 426 by using a weighted algorithm that calculates a service level indicator for each network based on the network characteristics determined by the network query module 402. For example, the service level module 426 may calculate a service level indicator, in one embodiment, by simply adding up values of the characteristic indicators. Referring to Table 1, the service level of NET01 may be calculated in this manner to be 10+1+10+5+5+10=41. Table 2 shows an example of the service levels of each of the four available networks shown in Table 1.

TABLE 2
Network Service Level

| | NET01 | NET02 | NET03 | NET04 |
|---|---|---|---|---|
| Service_Level | 41 | 37 | 42 | 27 |

In an alternative embodiment, the service level module 426 may calculate a service level indicator using a weighted algorithm that weighs each of the network characteristics according to a default, user-defined, or application-specific profile. Table 3 shows an example profile, PRFL01, that may be used to calculate the service level of a network using a weighted algorithm.

TABLE 3
Profile

| | PRFL01 |
|---|---|
| Low_Cost | 4 |
| High_Security | 7 |
| High_Bandwidth | 4 |
| Strong_Signal_Strength | 9 |
| Long_Time_Remaining | 2 |
| Mobility | 10 |

By multiplying the values for NET01 in the network profile of Table 1 by the corresponding values in the profile of Table 3, the service level of NET01 may be calculated to be (10×4)+(1×7)+(10×4)+(5×9)+(5×2)+(10×10)=242. Table 4 shows an example of the service levels of each of the four available networks of Table 1 using this weighted algorithm and the profile of Table 3.

TABLE 4
Network Service Level

| | NET01 | NET02 | NET03 | NET04 |
|---|---|---|---|---|
| Service_Level | 242 | 224 | 234 | 206 |

In a further embodiment, the service level module 426 may employ actual network characteristics, such as the actual cost of use per time unit or the actual bandwidth of the network and so forth. Using the actual network characteristics, the service level module 426 may calculate the service level of a specific network using either a weighted or a non-weighted algorithm. In the case of using weighting factors, designated by the subscripted variable W, the algorithm may be as follows:
Service Level=(W_{cost}×cost⁻¹)+(W_{security}×security)+(W_{bandwidth}×bandwidth)+(W_{strength}×signal strength)+(Wₜᵢₘₑ×time)+(W_{mobility}×mobility)

For one or more of the network characteristics, the actual characteristic may be used or an indicator may be used where a characteristic does not have necessarily have a specific quantity, such as where the security level may be designated as “high” instead of by a certain number. Table 5 shows one example of the service levels of a network using the listed characteristics and corresponding weighting factors.

TABLE 5
Profile Weighting Factors and Network Service Level

| | QTY | VALUE | W |
|---|---|---|---|
| Low_Cost | $5/unit | 0.2 | 1000 |
| High_Security | high | 10 | 10 |
| High_Bandwidth | 11 mbs | 11 | 1 |
| Strong_Signal_Strength | 14 dB | 14 | 1 |
| Long_Time_Remaining | 45 min | 45 | 1 |
| Mobility | high | 10 | 1 |
| SERVICE LEVEL | | | 380 |

It will be appreciated that the algorithm employed by the service level module 426 may employ a variety of mathematical functions to determine the service level of a given network. Additionally, the service level module 426 may be configured, in one embodiment, to use a different algorithm for each distinct network or type of network, depending on the design of the default, user-defined, and application-specific profiles, as well as the desired functionality of the network selection apparatus 400.

The best network module 428 of the determination module 404 is configured, in one embodiment, to determine which of the available networks might best meet the needs of the particular electronic computing device 200, possibly considering a user profile or an application profile. The best network module 428 may use the service level of each of the available networks as determined by the service level module 426. In an alternative embodiment, the best network module 428 may determine a best network based on the type of network available or a combination of two or more network characteristics.

The evaluation module 430 of the determination module 404 is configured, in one embodiment, to evaluate the actual network characteristics of an available network at a time after the electronic computing device 200 has begun data communications over the network. In other words, after the network computing device 200 has connected to a best network based on the determination by the best network module 428, the evaluation module 430 may periodically or otherwise re-evaluate the actual network characteristics to see if performance, such as bandwidth or security level, of the connected network has changed since the original connection.

The service level module 426 may be further configured to determine a new service level for an available network if the network characteristics have changed since a previous service level determination. Likewise, the best network module 428 may use the newly determined service levels to make a new determination as to the new best available network.

The network connection module 406 of the network selection apparatus 400 may be configured, in one embodiment, to connect to an available network by employing the communications adapter 212 of the electronic computing device 200. Upon determination of a best network, the network connection module 406 is configured to connect the electronic computing device 200 to the best network. Likewise, the dynamic switching module 432 is configured, in one embodiment, to disconnect the electronic computing device 200 from a previous best network and connect the electronic computing device to a new best network, such as when the performance or service level of the previous best network falls below that of another available network. The dynamic switching module 432 maybe further configured to switch the electronic computing device 200 from the previous best network to the new best network at a time that does not interrupt, or only minimally interrupts, the data communications of the electronic computing device 200.

The profile module 408 of the network selection apparatus 400 is configured, in one embodiment, to store a plurality of profiles that characterize either an actual network profile or a desired network profile. The depicted profile module 408 is configured to store a default profile 434, a user-defined profile 436, an application profile 438, and a network profile 440. The network profile 440 of the profile module 408 is substantially similar to the network profiles described above and shown in Table 1.

As with the network profile 440, the default profile 434, user-defined profile 436, and application profile 438 each contain a plurality of network characteristics. The default profile 434, user-defined profile 436, and application profile 438, however, contain desired network characteristics instead of reported or actual network characteristics. Additionally, the network characteristics within each of these profiles 434, 436, 438 may be stored in the form of raw values, ranked values, independently scaled values, or stored using any other appropriate valuation scheme.

Each of these profiles 434, 436, 438 may be tailored to provide a certain service level or to maximize the importance of a single network characteristic or specific combination of desired network characteristics. Table 6 shows an example of default, user-defined, and application profiles 434, 436, 438.

As shown in Table 6, for example, the default profile 434 designated as DFT01 favors low cost and wireless Wi-Fi networks over other types of networks and other network characteristics. Similarly, DFT02 favors exclusively wireless Bluetooth networks. This may be due to limited means to connect to a network other than using wireless Bluetooth means. The user-defined profile 436 designated as USR01 may be defined by a user for a specific application, network combination, or any other factor of importance to the user. For example, USR01 is defined to favor high bandwidth and broadband or wireless Wi-Fi networks. Also, USR01 favors signal strength and connection time over cost or security of the available network.

TABLE 6
Default, User-Defined, and Application Profiles

| | DFT01 | DFT02 | USR01 | APP01 |
|---|---|---|---|---|
| Low_Cost | 10 | 4 | 5 | 3 |
| High_Security | 6 | 7 | 4 | 10 |
| High_Bandwidth | 3 | 4 | 10 | 8 |
| Strong_Signal_Strength | 5 | 9 | 8 | 3 |
| Long_Time_Remaining | 0 | 2 | 8 | 4 |
| Mobility | 7 | 10 | 4 | 0 |
| Type_Wired_ISDN | 5 | 0 | 6 | 10 |
| Type_Wired_Broadband | 9 | 0 | 10 | 1 |
| Type_Wired_WAN | 6 | 0 | 9 | 2 |
| Type Wired_LAN | 7 | 0 | 8 | 2 |
| Type_Wireless_WAN | 8 | 0 | 7 | 0 |
| Type_Wireless_Wi-Fi | 10 | 0 | 10 | 3 |
| Type_Wireless_BT | 4 | 10 | 0 | 0 |

The application profile 438 designated as APP01 may correspond to a specific application program on the electronic computing devices 200. For example, APP01 may correspond to an internet banking application that prefers high security at the expense of low cost or mobility.

A single profile module 408 within a network selection apparatus 400 may have a variety of profiles 434, 436, 438, 440 depending on the default and user-defined settings, as well as the number of active networks available to a single electronic computing device 200. Given the variety of profiles 434, 436, 438, 440 that may be used in determining a best network service, the service level module 426 may also calculate a service level based a difference between the default profile 434, user-defined profile 436, or application profile 438 and the network profiles 440 of the available networks.

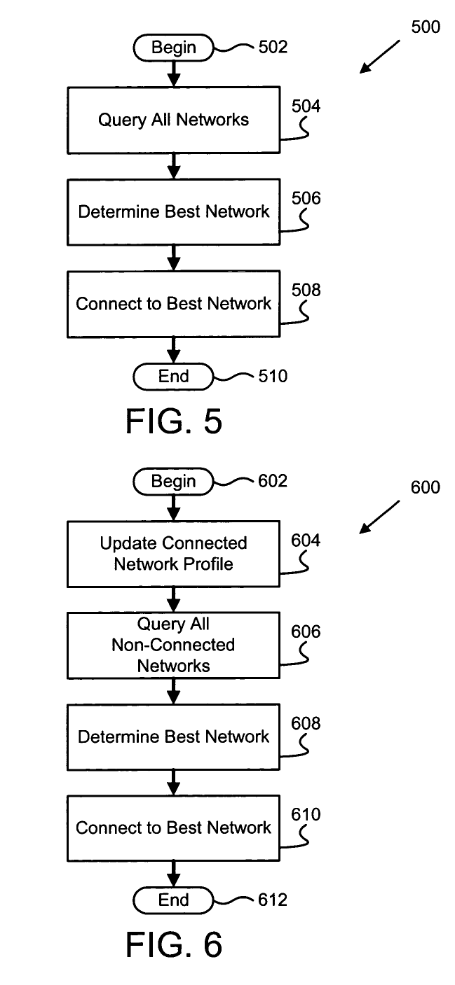

FIG. 5 depicts one embodiment of a dynamic network selection process 500 that may be employed by the network selection apparatus 400 of FIG. 4. The depicted dynamic network selection process 500 begins 502 as the network selection apparatus 400 queries 504 all available networks. In one embodiment, the network selection apparatus 400 may employ the network query module 402 to obtain the network type and network characteristics for each available network.

The dynamic network selection process 500 continues as the network selection apparatus determines 506 the best network from the available networks and then connects 508 to the best network. In one embodiment, the network selection apparatus 400 may employ the determination module 404 and the best network module 428 to determine 506 the best available network. The network selection apparatus 400 also may employ the profile module 408 to determine the best available network according to a preferred profile, such as a default profile 434, a user-defined profile 436, or an application profile 438. Likewise, the network selection apparatus 400 may employ the network connection module 406 to connect 508 and establish data communications with the electronic computing device 200 to the best available network. The dynamic network selection process 500 then ends 510.

FIG. 6 depicts one embodiment of a dynamic network selection process 600 that is similar to the dynamic network selection process 500 of FIG. 5. The depicted dynamic network selection process 600 is substantially similar to the dynamic network selection process 500 shown in FIG. 5 and may be employed by the network selection apparatus 400 after the electronic computing device 200 is already connected to an available network.

The dynamic network selection process 600 begins 602 by updating 604 the network profile 440 of the network to which the electronic computing device 200 is currently connected. In one embodiment, the network selection apparatus 400 may employ the evaluation module 430 and network query module 402 to determine the current, actual network characteristics of the connected network. The network selection apparatus 400 may further employ the profile module 408 to update 604 the network profile 440 of the connected network.

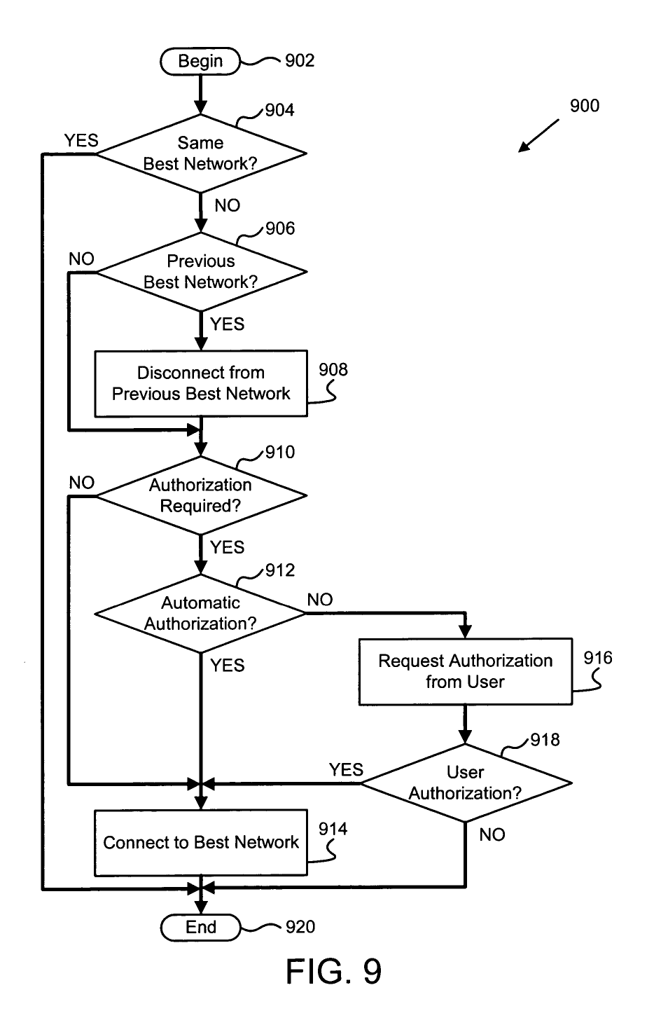

After updating 604 the network profile 440 of the currently connected network, the network selection apparatus 400 queries 606 the remaining available networks, such as by employing the network query module 402. As depicted in FIG. 5 and described above, the network selection apparatus 400 then determines 608 a best network from the available networks and connects 610 the electronic computing device 200 to the best network. The determination step 608 and the connection step 610 are substantially similar to the determination step 506 and the connection step 508, respectively, shown in FIG. 5. The connection step 610 may also include disconnecting from a previous best network when the currently connected network is not determined to be the new best network. This will be described in more detail with reference to FIG. 9. The depicted dynamic network selection process 600 then ends 612.

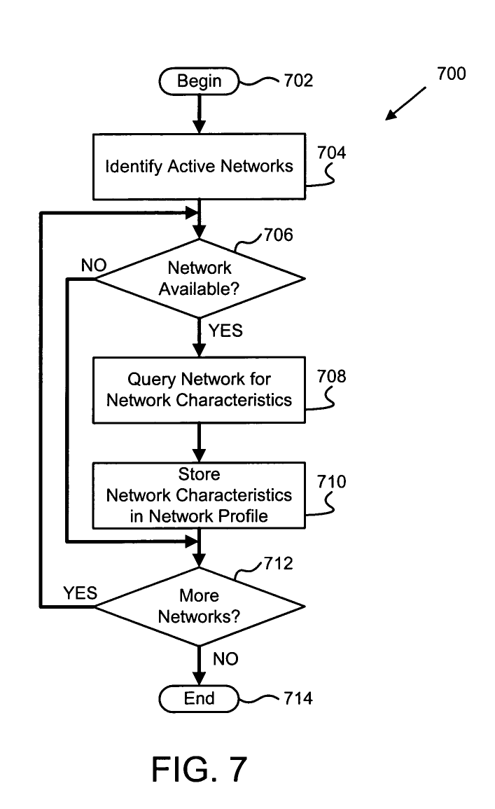

FIG. 7 illustrates one embodiment of a network query process 700 that may be representative of the query step 504 of the dynamic network selection process 500 of FIG. 5. The depicted network query process 700 begins 702 by identifying 704 the active networks that are operational near a specific electronic computing device 200. After a network selection apparatus 400 identifies 704 the active networks, the network selection apparatus 400 determines 706 if the active networks are available to the electronic computing device 200. A network may be active, but unavailable to an electronic computing device 200 if, for example, the user does not have security access to the active network or the user is not a subscriber to a particular closed network.

If the network selection apparatus 400 determines 706 that an active network is available to the user of the electronic computing device 200, the network selection apparatus 400 then queries 708 the available network for the corresponding network characteristics. In one embodiment, the network selection apparatus 400 may employ the network query module 402 to query 708 the available network for the network characteristics. The network selection apparatus 400 then stores 710 the network characteristics for the available network in a network profile 440, such as by employing the profile module 408.

After storing 710 the network characteristics in the network profile 440, or after determining 706 that an active network is unavailable, the depicted network query process 700 determines 712 if all active networks have been analyzed. If an active network has not been analyzed, the network query process 700 returns to determine 704 if another of the active networks is available to the electronic computing device 200 and, if so, repeats the network query steps described above. Otherwise, if all of the active networks have been analyzed, the network query process 700 ends 714.

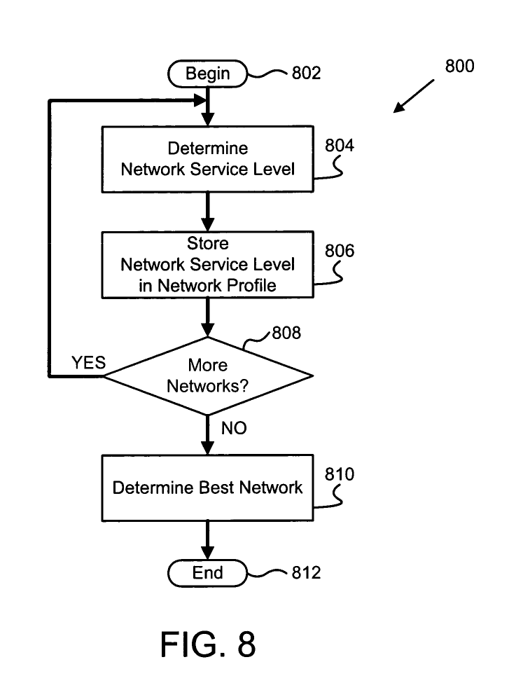

FIG. 8 illustrates one embodiment of a determination process 800 that may be representative of the determination step 506 of FIG. 5 or the determination step 608 of FIG. 6. The depicted determination process 800 begins 802 by determining 804 a network service level for a specific available network. The network selection apparatus 400, in one embodiment, may employ the service level module 426 to determine 804 the network service level for the available network. The network selection apparatus 400 then stores 806 the network service level in a network profile 440. The determination process 800 then determines if all available networks have been assigned a service level and, if not, the determination process 800 returns to determine 804 and store 806 the service levels for the remaining available networks.

After all available networks have been assigned a service level, the network selection apparatus 400 determines a best network 810 based on the service levels of each of the available networks. In one embodiment, the available network with the highest service level is determined 810 to be the best network. The network selection apparatus 400 may employ the best network module 428, in a certain embodiment, to determine 810 the best network. The depicted determination process 800 then ends 812.

FIG. 9 illustrates one embodiment of a network connection process 900 that may be representative of the connection step 610 of the dynamic network selection process 600 of FIG. 6. The depicted network connection process 900 begins 902 by determining 904 if the best available network is the currently connected network. If the electronic computing device 200 is already connected to the best available network, there is no need to modify the network connection.

If the best available network is different from the currently connected network, the network selection apparatus 400 determines 906 if the electronic computing device 200 is currently connected to a previous best network. A previous best network may be a network that was previously determined to be a best network, but is no longer the best network due to decreased performance, changed location, application program requirements, and so forth. If the electronic computing device 200 is currently connected to a previous best network, the network selection apparatus 400 disconnects 908 the electronic computing device from the previous best network, such as by employing the dynamic switching apparatus 432.

In another embodiment, the network selection apparatus 400 may wait to disconnect 908 the electronic computing device 200 from a previous best network until the connection to the new best network is fully authorized and ready to transfer current data communications. In a further embodiment, the network selection apparatus 400 may disregard service levels of non-connected networks that are only minimally better than the service level of the current best network. For example, a user-defined profile 436 may include a service level differential parameter that may specify a minimum difference between service levels that is required before the network switching apparatus 400 will dynamically switch to a new best network. The service level differential parameter may be specified as a percentage, a raw value, or another format that distinguishes the service level of a current best network and the service level of a non-connected network.

In the depicted embodiment, after the electronic computing device 200 is disconnected 908 from a previous best network, or if the electronic computing device 200 is not currently connected to any networks, the network selection apparatus 400 determines 910 if authorization is required to connect to the best network. If authorization is required to connect to the best network, the network selection apparatus 400 determines 912 if the authorization is automatic, such as through dynamic assignment of an internet protocol (IP) address.

Another example of authorization that may be automatic is an internet service subscriber whose laptop and wireless card are already configured to establish a network connection to a wireless LAN network without further authorization from the subscriber. In this case, the IP address and other network configuration settings, including security keys and codes, may be automatic or may have been previously entered and stored within the laptop.

If the network selection apparatus 400 determines 912 that the authorization is automatic, the network selection apparatus 400 then connects 914 to the best available network. Similarly, if the network selection apparatus 400 determines 910 that authorization is not required, the network selection apparatus 400 then connects 914 to the best network. In one embodiment, the network selection apparatus 400 employs the network connection module 406 to connect to the best available network. In a further embodiment, the network selection apparatus 400 also employs the dynamic switching module 432 to connect to a new best network.

If the network selection apparatus 400 determines 912 that the authorization is not automatic, the depicted network connection process 900 requests 916 authorization from the user, such as through requesting a security code, a logon username and password, or some other form of network authorization. If user authorization is required, the network connection process 900 determines 918 if proper authorization has been provided and, if so, connects 914 to the best network.

If user authorization is required, but is not provided, the network connection process may end 920 without connecting 914 to the best network. However, in an alternative embodiment, the electronic computing device 200 may remain connected to a previous best network until authorization is fully realized for a new best network. After remaining connected to the same best network, connecting 914 to a new best network, or in some circumstances possibly disconnecting from all networks, the depicted network connection process 900 ends 920.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network selection apparatus for inclusion within an electronic computing device to determine a best network service for the electronic computing device, the apparatus comprising:
a network query module configured to query a first network for a plurality of first network characteristics and to query a second network for a plurality of second network characteristics;
a service level module configured to determine a first network service level based on the plurality of first network characteristics and to determine a second network service level based on the plurality of second network characteristics;
a best network module configured to determine a best network from the first and second networks based on the first and second service levels; and
a network connection module configured to dynamically connect the electronic computing device to the best network.

2. The apparatus of claim 1, wherein the service level module is further configured to determine the first network service level based on an influenced algorithm by allowing one of the plurality of first network characteristics to influence the determination of the first service level a first amount and allowing another of the plurality of first network characteristics to influence the determination of the first service level a second amount.

3. The apparatus of claim 3, wherein the first amount is equal to the second amount.

4. The apparatus of claim 3, wherein the first amount is greater than the second amount.

5. The apparatus of claim 1, further comprising an evaluation module configured to evaluate a plurality of actual best network characteristics.

6. The apparatus of claim 5, wherein the service level module is further configured to determine an actual best network service level based on the influenced algorithm using the plurality of actual best network characteristics.

7. The apparatus of claim 1, further comprising a dynamic switching module configured to dynamically disconnect the electronic computing device from a previously best network before the network connection module dynamically connects the electronic computing device to the best network.

8. The apparatus of claim 1, further comprising a profile module configured to maintain a profile, the profile comprising a plurality of profile characteristics.

9. The apparatus of claim 8, wherein the profile comprises a default user profile, the default user profile comprising a plurality of default user preference levels associated with the plurality of profile characteristics.

10. The apparatus of claim 8, wherein the profile comprises a user-defined profile, the user-defined profile comprising a plurality of user-defined preference levels associated with the plurality of profile characteristics.

11. The apparatus of claim 8, wherein the profile comprises a minimum service level.

12. The apparatus of claim 8, wherein the profile comprises an application profile, the application profile comprising a plurality of application preference levels associated with the plurality of profile characteristics.

13. The apparatus of claim 8, wherein the profile comprises a first network profile and a second network profile, the first network profile comprising a plurality of first network characteristics associated with the first network, the second network profile comprising a plurality of second network characteristics associated with the second network.

14. The apparatus of claim 1, wherein the plurality of first network characteristics comprises at least two characteristics selected from the group consisting of a network type indicator, a cost indicator, a security indicator, a bandwidth indicator, a signal strength indicator, a time remaining indicator, and a mobility indicator.

15. A system for determining a best network service for an electronic computing device, the system comprising:
an electronic computing device having a central processing unit, an electronic storage device, a user interface adapter, and a communications adapter;
a first network connection adapter and a second network connection adapter that is different than the first network connection adapter, the first network adapter configured to connect to a first network and the second network adapter configured to connect to a second network; and
a network selection apparatus resident within the electronic computing device, the network selection apparatus configured to use an influenced algorithm to process a plurality of first network characteristics and a plurality of second network characteristics to dynamically select a best network from the first and second networks.

16. A system for determining a best network service for an electronic computing device, the system comprising:
a first network;
a second network;
an electronic computing device having a first connection adapter and a second connection adapter, the first connection adapter configured to connect to the first network and the second network adapter configured to connect to the second network;
a network query module resident within the electronic computing device, the network query module configured to query the first network for a plurality of first network characteristics and to query the second network for a plurality of second network characteristics;
a service level module resident within the electronic computing device, the service level module configured to determine a first network service level based on an influenced algorithm using the plurality of first network characteristics and to determine a second network service level based on the influenced algorithm using the plurality of second network characteristics;
a best network module resident within the electronic computing device, the best network module configured to determine a best network from the first and second networks based on the first and second service levels; and
a network connection module resident within the electronic computing device, the network connection module configured to dynamically connect the electronic computing device to the best network.

17. A network selection process for determining a best network service for an electronic computing device, the process comprising:
querying a first network for a plurality of first network characteristics and querying a second network for a plurality of second network characteristics;
determining a first network service level based on the plurality of first network characteristics and determining a second network service level based on the plurality of second network characteristics;
determining a best network from the first and second networks based on the first and second service levels; and
dynamically connecting the electronic computing device to the best network.

18. The process of claim 17, wherein determining a first network service level further comprises determining the first network service level based on an influenced algorithm by allowing one of the plurality of first network characteristics to influence the determination of the first service level a first amount and allowing another of the plurality of first network characteristics to influence the determination of the first service level a second amount.

19. The process of claim 17, further comprising evaluating a plurality of actual best network characteristics.

20. The process of claim 19, further comprising determining an actual best network service level based on the influenced algorithm using the plurality of actual best network characteristics.

21. The process of claim 17, further comprising dynamically disconnecting the electronic computing device from a previously best network before dynamically connecting the electronic computing device to the best network.

22. The process of claim 17, further comprising maintaining a profile, the profile comprising a plurality of profile characteristics.

23. The process of claim 22, wherein the profile comprises a default user profile, the default user profile comprising a plurality of default user preference levels associated with the plurality of profile characteristics.

24. The process of claim 22, wherein the profile comprises a user-defined profile, the user-defined profile comprising a plurality of user-defined preference levels associated with the plurality of profile characteristics.

25. The process of claim 22, wherein the profile comprises an application profile, the application profile comprising a plurality of application preference levels associated with the plurality of profile characteristics.

26. The process of claim 22, wherein the profile comprises a first network profile and a second network profile, the first network profile comprising a plurality of first network characteristics associated with the first network and the second network profile comprising a plurality of second network characteristics associated with the second network.

27. The process of claim 17, wherein the plurality of first network characteristics comprises at least two characteristics selected from the group consisting of a network type indicator, a cost indicator, a security indicator, a bandwidth indicator, a signal strength indicator, a time remaining indicator, and a mobility indicator.

28. A network selection process for determining a best network service for an electronic computing device, the process comprising:
querying a first network for a plurality of first network characteristics and querying a second network for a plurality of second network characteristics, the plurality first and second network characteristics each comprising at least two characteristics selected from the group consisting of network type, cost, security, bandwidth, signal strength, time remaining, and mobility;
determining a first network service level based on an influenced algorithm using the plurality of first network characteristics and determining a second network service level based on the influenced algorithm using the plurality of second network characteristics;
determining a best network from the first and second networks based on the first and second service levels;
dynamically connecting the electronic computing device to the best network;
maintaining a profile that comprises a plurality of profile characteristics, including a minimum service level;
maintaining a default user profile that comprises a plurality of default user preference levels associated with the plurality of profile characteristics;
maintaining a user-defined profile that comprises a plurality of user-defined preference levels associated with the plurality of profile characteristics;
maintaining an application profile that comprises a plurality of application preference levels associated with the plurality of profile characteristics;
maintaining a first network profile that further comprises a plurality of first network characteristics associated with the first network;
maintaining a second network profile that further comprises a plurality of second network characteristics associated with the second network;
evaluating a plurality of actual best network characteristics;
determining an actual best network service level based on the influenced algorithm using the plurality of actual best network characteristics; and
dynamically disconnecting the electronic computing device from a previously best network before dynamically connecting the electronic computing device to the best network.

29. A computer readable storage medium comprising computer readable code configured to carry out a network selection process for determining a best network service for an electronic computing device, the process comprising:
querying a first network for a plurality of first network characteristics and querying a second network for a plurality of second network characteristics;
determining a first network service level based on an influenced algorithm using the plurality of first network characteristics and determining a second network service level based on the influenced algorithm using the plurality of second network characteristics;
determining a best network from the first and second networks based on the first and second service levels; and
dynamically connecting the electronic computing device to the best network.

30. An network selection apparatus for determining a best network service for an electronic computing device, the apparatus comprising:
means for querying a first network for a plurality of first network characteristics and querying a second network for a plurality of second network characteristics;
means for determining a first network service level based on an influenced algorithm using the plurality of first network characteristics and determining a second network service level based on the influenced algorithm using the plurality of second network characteristics;
means for determining a best network from the first and second networks based on the first and second service levels; and
means for dynamically connecting the electronic computing device to the best network.
